(19) United States
(12) Patent Application Publication
(10) Pub. No.: US 2007/0094720 A1
(43) Pub. Date: Apr. 26, 2007

(54) Security system

(76) Inventor: Charles Galambos, Guildford (GB)

Correspondence Address: STITES & HARBISON PLLC, 1199 NORTH FAIRFAX STREET, SUITE 900, ALEXANDRIA, VA, 22314, US

(21) Appl. No.: 11/514,353

(22) Filed: Sep. 1, 2006

(30) Foreign Application Priority Data
Sep. 1, 2005 (GB) 0517801.7

(51) Int. Cl. H04L 9/32

(52) U.S. Cl. 726/9

(57) ABSTRACT

A method of updating a local security system is described. The security system is linked to a central server, and security updates and/or alert notices generated by information provided by a third party to the central server, are transmitted from the central server to the local security system.

This invention relates to a method of updating a local security system.

Increasingly, security systems are using more and more sophisticated object detection and recognition algorithms to analyse data. Such analysis requires complex models to distinguish between observed events which are benign and those observed events to which the user of the security system should be alerted. In many cases setting up the model to recognise such benign/dangerous events is beyond what is expected for security personnel and the people who manage the security system on a day-to-day basis.

According to the invention there is provided a method of updating a local security system from a central server, wherein said central server provides one or more security updates and/or alert notices to said local security system, said security updates and/or alert notices are generated according to information provided by a third party to said central server.

According to the invention there is also provided a security system comprising at least one local security system and a central server connected to said at least one local security system, said central server provide one or more security updates and/or alert notices to said at least one local security system, said security updates and/or alert notices are generated by said central server according to information provided to said central server by a third party.

The update system will work much like the virus checker model found on modern computers where users subscribe to a central server to obtain updates, but in this invention the security up-dates and/or alert notice are provided by a third party to the central server.

The updates provided by the central server may be tailored to the location and type of business which the local security system is for.

A security system embodying the invention is now described, by way of example only, with reference to the accompanying figures in which:—

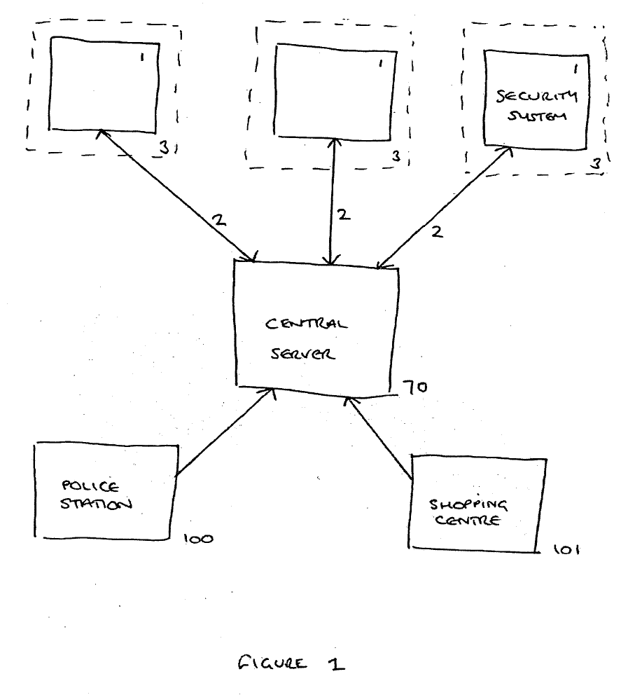

FIG. 1 shows a central server connected to several local security systems as well as to other facilities.

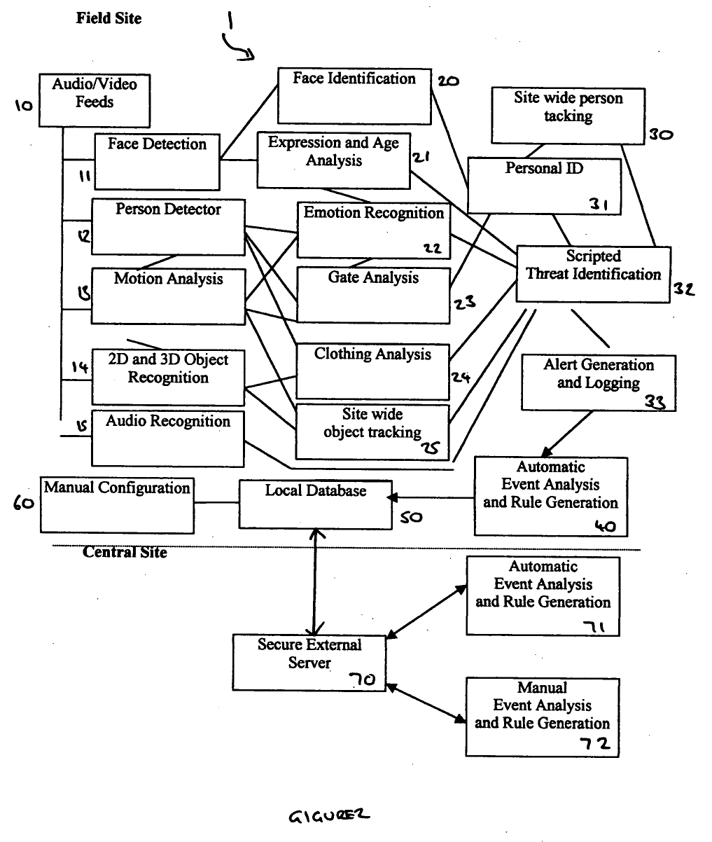

FIG. 2 shows the component modules of the local security system and central server.

FIG. 1 shows the various elements which make up the overall system. There are a plurality of local security systems (1) for businesses (3). Each local security system (1) is in communication with a central server (70) via an encrypted, authenticated link (2). The central server (70) is also in communication with a police station (100) and a shopping centre (101). The central server (70) may also be linked to other community facilities (not shown).

FIG. 2 shows the overall construction of a local security system (1) and the central server (70).

The local security system (1) of business (3) has an audio card/or video feed (10). Various primary modules within the local security system (1) are used to analyse data acquired by the audio card/or video feed (10). These include face detection module (11), person detection module (12), motion analysis module (13), 2D/3D object recognition module (14) and audio recognition module (15). Other modules (not shown) may also be used to analyse the data acquired by audio card/or video feed (10).

The analysed data then passes to secondary modules for further analysis.

For example, the output from face detection module (11), is input to face identification module (20) and/or expression and age analysis module (21). The output from person detection module (12) is output to emotion recognition module (22), gait analysis module (23) and clothing analysis module (24). Data can also be provided to emotion recognition module (22) from expression and age analysis module (21).

The output from motion analysis module (13) is input to emotion recognition module (22), gait analysis module (23) and clothing analysis module (24).

The output from 2D/3D object recognition module (14) is input to clothing analysis module (24) and object tracking module (25).

Of course, the outputs from any of the primary analysis modules may be input to any of the secondary analysis modules.

The final modules within the local security system (1) are used to identify possible threats to the businesses (3). These include person tracking module (30), personal identification module (31), scripted threat identification module (32) and alert module (33).

The personal identification module (31) receives data from face identification module (20) and gait analysis module (23). Data from the personal identification module (31) is provided to the person tracking module (30).

The scripted threat identification module (32) receives data from expression and age analysis module (21), emotion recognition module (22), clothing analysis module (24), object tracking module (25), person tracking module (30) and audio recognition module (15).

The alert module (33) receives information from the scripted threat identification module (32). This module (33) performs automatic event analysis and rule generation (40). The results of the automatic event analysis and generated rules are passed to a local database (50).

The local database (50) is also used by all of the above described primary, secondary and final processing modules to store both their present configuration and target details.

The secure central server (70) includes event analysis and rule generation modules (71, 72). One module (71) is automatic, and the other module (72) is manual.

The central server (70) is connected to the local security system (1) via an encrypted and authenticated link (2). The central server (70) is configured to receive and transmit information to and from all the systems (local security system (1), police station (100), shopping centre (101)) to which it is connected. For example, the central server (70) may receive information from police station (100) about suspicious or stolen vehicles which may be in the local area. The central server (70) may also receive information on hire vehicles which may be in the local area. These vehicles are sometimes difficult to trace and may be used for criminal activities.

The central server (70) may also receive information on authorized vehicles used by the emergency services or companies who are not considered to be a threat to any of the local businesses (3). These may include, for example, courier companies or taxi companies. In the case of vehicle information the central server (70) will receive information on the licence plate of the vehicle, other details of the vehicle, and possible biometric information on the driver and any passengers within the vehicle.

The vehicle details obtained by the central server (70) may also be cross checked by reporting the presence of the vehicle to another authority (not shown) which is able to verify the authenticity of the vehicle. This may involve checking the registration number plate found using automatic recognition matches to a stored description of the vehicle.

The central server (70) can also receive information on people who may be in the region. This information can include identification details of people with known criminal records, or possibly on a security watch list or some other reason. The identification information is preferably in the form of biometric data, including, but not limited to gender identification, face identification, body type, gait and posture and behaviour identification.

The central server (70) can receive information on dangerous objects which may be used during an offence. The objects may include any type of offensive weapon. Of course, there are a vast range of such weapons available to people who may wish to use them. The central server (70) (and local security systems (1)) will need to be regularly updated with current models of the objects to keep them secure. The central server (70) may also receive information on subjects who are wearing particularly unseasonable clothing, or clothing which obscures a substantial part of their face, thereby impeding identification of the subject.

Also, the central server (70) may receive information on the behaviour of subjects in the local area. Once again, the central server (70) and local security systems (1) will need to be regularly updated with models of dangerous, threatening and criminal behaviour to keep the security system secure.

In the above description all of the information is received at the central server (70) from the police station (100). However, the information can be received from another local security system (1) or from community facilities to which the central server (70) is connected.

Once the central server (70) has received the information it can send security updates and/or alerts to one or more of the local security systems (1). These alerts may be that a particular vehicle is or may be entering the ranges of the security system (1); or that a particular subject is or may be entering the range of the security system (1); or that a particular object (e.g. an offensive weapon) is or may be entering the range of the security system (1).

The security updates and/or alert notices may be digitally signed and may be sent to the local security system (1) via an encrypted and authenticated link (2). The security updates and/or alert notices may be provided to the local security system (1) at regular intervals or (e.g. every hour) immediately after they have been generated.

Typically, the local security system (1) will subscribe to an update service of the central server (70) and the security updates and/or alert notices will be provided automatically. The update service may be provided for free, or a charge may be levied by the operator of the central server (70).

Once the security update and/or alert notice is received by a local security system (1), the security system (1) will combine the received information with information from the audio/visual feed (10) to determine if the vehicle/person/object as the subject of the security update/alert notice has entered the range of the security system (1).

If the vehicle/person/object has entered the range of local security system (1) then alert module (33) will raise an alert of the possible danger. The local security system (1) will also look for any stolen vehicles which may park on or near to the premises of the business (3). Also, the local security system (1) can monitor vehicles which are parked in designated no parking zones, and how long the vehicle is parked in the zone. If details of these parked vehicles match details provided in a security update/alert notice, the local security system (1) will raise an alert of possible danger.

The security update/alert notices received from the central server (70) by the local security system (1) may be used with the information obtained from audio/visual feed (10) in several different ways. Various examples are now described:

The security update/alert notice may provide information on people who may be on a specific watch list. For example, if a subject with a history of shop lifting is sighted outside premises of the type they have previously targeted a security update/alert notice should be provided to local security system (1) from central server (70).

Specific information may be provided in the security update/alert notice. This will cut down the watch list to be searched for people entering and exiting gender restricted areas e.g. public toilets.

Security update/alert notices may also be provided to customs for example, and the identity of people who hesitate before passing through customs barriers, can be compared with the identity of people who may be on a customs watch list.

With regard to details of subjects on a watch list, if a subject is known to be in another part of the world, or is in prison for example, that subject can be removed from the watch list for an appropriate period of time.

The security update/alert notice may also provide information on the age range of a subject. This may be useful if the subject is approaching a business which is restricted to adults, for example an off-licence, gaming arcade or betting shop. If a minor is approaching a business of this type an alert will be raised by the local security system (1) using the information from the security update/alert notice.

The local security system (1) can also be used to verify the identity of all the people who are entering a secure area of the business having previously been through an appropriate security procedure. This can be used to prevent tail gating by an unauthorized subject by having a small area before a secure door in which either security cameras or other sensors can check all the subjects present in the area are authorized to enter the area. A similar check can be used after the secure door to check all subjects who appear on the other side of the secure door are authorized to do so. This approach is advantageous where physical or performance constraints prevent a more sophisticated security system being used.

The local security system can also be used to check that all personnel within a building are wearing the appropriate security badge. This will prevent subjects passing security badges outside which may allow unauthorized people to enter. If the security badge has clear enough marking it would also be possible to use either face recognition or other biometric verification procedures to check that the security badge is being worn by the genuine owner.

The local security system (1) manually or automatically downloads security updates and/or alert notices from the central server and optionally uploads information and/or alerts about any security problems at the local business to central server (70). The information uploaded from the local security system to the central server may include audio information e.g. speech analysis, movies such as screams, shouting.

The uploading of alerts from the local security system (1) to the central server (70) along encrypted and authenticated link (27) will allow analysis of false alerts by the central server (70). This analysis can be used to refine further security updates and/or alert notices to be subsequently sent out to local security system (1). For example, the face template of a subject may be further refined using details captured by the audio/visual feed (10) of a local security system.

The central server may use a biometric (particularly face based) based watch list to generate the security update/alert notices. Use of this biometric data can be enhanced if they are used in conjunction with generic behaviour models to trigger the alert. For example, if a subject on the watch list starts to behave suspiciously then the central server (70) should generate a security update/alert notice.

Security data provided in the uploaded alerts from the local security system (1) to central server (70) may be automatically refined by the central server (70) and used to provide further security updates/alert notices.

The security data provided in the uploaded alerts may be automatically or manually reviewed by the central server (70) to be used in further security updates/alert notices.

1. A method of updating a local security system from a central server, wherein said central server provides one or more security updates and/or alert notices to said local security system, said security updates and/or alert notices are generated according to information provided by a third party to said central server.

2. A method according to claim 1 wherein said local security system subscribes to said central server and said security updates and/or alert notices are provided automatically.

3. A method according to claim 1 or claim 2 wherein said security updates and/or alert notices are provided to said local security system via an encrypted and authenticated link.

4. A method according to any preceding claim wherein said security updates and/or alert notices are provided to said local security system at regular intervals.

5. A method according to any one of claims 1-3 wherein said security updates and/or alert notices are provided to said local security system immediately after they have been generated by said central server.

6. A method according to any preceding claim wherein said security updates and/or alert notices are digitally signed.

7. A method according to any preceding claim wherein said security updates and/or alert notices include information on one or more vehicles which may pass within range of said local security system.

8. A method according to claim 7 wherein said information on vehicles includes information that a said vehicle is a stolen vehicle.

9. A method according to claim 7 or claim 8 wherein said information on vehicles includes information that a further said vehicle is an authorized vehicle.

10. A method according to claim 9 wherein said authorized vehicle is an emergency services vehicle.

11. A method according to claim 9 wherein said authorized vehicle is a vehicle with prior authorization to enter said range of said local security system.

12. A method according to any one of claims 7 to 11 wherein said information on vehicles includes information that a said vehicle is a rental vehicle.

13. A method according to any preceding claim wherein said security updates and/or alert notices include information on one or more objects which may pass within range of said local security system.

14. A method according to claim 13 wherein said information on objects includes information that a said object is a gun.

15. A method according to one of claims 13 or 14 wherein said information on objects includes information that a said object is a knife.

16. A method according to any preceding claim wherein said security updates and/or alert notices include information on one or more subjects who may pass within range of said local security system.

17. A method according to claim 16 wherein said information on subjects includes information on the identity of a said subject.

18. A method according to claim 16 or claim 17 wherein said information on subjects includes information on the posture of said subject.

19. A method according to any one of claims 16 to 18 wherein said information on subjects includes information on the behaviour of the subject.

20. A method according to any one of claims 16 to 19 wherein said information on subjects includes information on whether a said subject has a criminal record.

21. A method according to any preceding claim wherein said third party is a police force.

22. A method according to any one of claims 1 to 20 wherein said third party is another local security system.

23. A method according to any one of claims 1 to 20 wherein said third party is a local community facility, such as a shopping centre.

24. A method according to any preceding claim wherein said security updates and/or alert notices are provided according to the location of the business said local security system is for.

25. A method according to any one of claims 1-23 wherein said security updates and/or alert notices are provided according to the type of business said local security system is for.

26. A method according to any preceding claim wherein said local security system also provides security information to said central server.

27. A method according to claim 26 wherein said security information provided by said local security system to said central server is manually or automatically reviewed by said central server.

28. A method according to claim 27 wherein said reviewed security information is used by said central server to provide further security updates and/or alert notices.

29. A security system comprising at least one local security system and a central server connected to said at least one local security system, said central server provide one or more security updates and/or alert notices to said at least one local security system, said security updates and/or alert notices are generated by said central server according to information provided to said central server by a third party.

30-31. (canceled)
